(19) United States
(12) Patent Application Publication
(10) Pub. No.: US 2022/0105925 A1
(43) Pub. Date: Apr. 7, 2022

(54) ONE PEDAL DRIVING

(71) Applicant: GM GLOBAL TECHNOLOGY OPERATIONS LLC, Detroit, MI (US)

(72) Inventors: Mohammad Naserian, Windsor (CA); Soheil Samii, Royal Oak, MI (US); Nathaniel S. Michaluk, Howell, MI (US)

(73) Assignee: GM GLOBAL TECHNOLOGY OPERATIONS LLC, Detroit, MI (US)

(21) Appl. No.: 17/060,698

(22) Filed: Oct. 1, 2020

(51) Int. Cl. B60W 30/09; B60W 50/00; B60W 10/08; B60W 30/18; B60W 30/095; B60W 10/18; B60W 40/105

(52) U.S. Cl. CPC B60W 30/09; B60W 50/0097; B60W 10/08; B60W 30/18127; B60W 30/0956; B60W 10/18; B60W 2420/52; B60W 2540/10; B60W 2520/10; B60W 2555/60; B60W 2554/402; B60W 2554/4045; B60W 2420/42; B60W 40/105

(57) ABSTRACT

Method and systems for one-pedal driving (OPD) control for a vehicle. The methods and systems determine that regenerative braking is to be applied based on accelerator pedal stroke data, predict an upcoming deceleration event based on sensor data from a sensor system of the vehicle, thereby providing deceleration prediction data, adjust a default braking profile based on the deceleration prediction data, generate a regenerative braking command based on the accelerator pedal stroke data and the adjusted braking profile, and output the regenerative braking command to a motor/generator of the vehicle.

The present disclosure generally relates to vehicles having regenerative braking capability, and more particularly relates to methods and systems for controlling one pedal driving.

One pedal driving (OPD) allows for a significant part of braking to be performed without using a brake pedal by invoking regenerative braking when an accelerator pedal is lifted from a cruising or acceleration region. A vehicle can be brought smoothly to a stop though an electric motor operating as an electric generator to recharge a battery when the accelerator pedal is held in a regenerative braking region. In some vehicles, one pedal driving can be enabled and disabled, and regenerative braking can be applied with greater braking force by operation of a paddle adjacent the steering wheel. Such vehicles rely on a driver identifying when additional regenerative braking can be applied and not all drivers will utilize all regenerative braking opportunities. Further, some drivers might prefer a simpler interface for optimally controlling regenerative braking than the combinate of an accelerator pedal and a steering wheel paddle. If braking force during OPD is set high, the vehicle may feel “jerky” in operation whereas if braking force during OPD is set low, battery regeneration may not be as efficiently managed as possible.

Accordingly, it is desirable to provide techniques for reliably and efficiently applying regenerative braking during OPD and for enhancing a driver experience for OPD. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In one aspect, a one-pedal driving (OPD) control system for a vehicle is provided. A sensor is operable to provide sensor data indicative of an upcoming deceleration event. A motor/generator operable to generate traction torque and regenerative braking torque for the vehicle. A processor is in operable communication with the sensor and the motor/generator. The processor is configured to execute program instructions. The program instructions cause the processor to receive accelerator pedal stroke data relating to an accelerator pedal. determine that regenerative braking is to be applied based on the accelerator pedal stroke data. predict an upcoming deceleration event based on the sensor data, thereby providing deceleration prediction data, adjust a default braking profile based on the deceleration prediction data, wherein the braking profile relates braking torque and at least pedal stroke position, generate a regenerative braking command based on the accelerator pedal stroke data and the adjusted braking profile, and output the regenerative braking command to the motor/generator.

In embodiments, the default braking profile relates at least accelerator pedal stroke position, vehicle speed and braking torque.

In embodiments, the program instructions cause the processor to determine whether an amount of liftoff of the accelerator pedal has reached a predetermined level based on the pedal stroke data, and, when the predetermined level has been reached, determine a target stop position based on the sensor data, set a deceleration trajectory to stop at the target position, and generate the regenerative braking command based additionally on the deceleration trajectory.

In embodiments, the program instructions cause the processor to generate the regenerative braking command based on the accelerator pedal stroke data and the default braking profile when no upcoming deceleration is predicted, and generate the regenerative braking command based on the accelerator pedal stroke data and the adjusted braking profile when upcoming deceleration is predicted. The adjusted braking profile has a greater rate of change of braking torque per unit accelerator pedal movement than the default braking profile.

In embodiments, the program instructions cause the processor to reset to generating the regenerative braking command based on the accelerator pedal stroke data and the default braking profile after the accelerator pedal stroke data indicates that the accelerator pedal has returned to a cruise or acceleration region or after the vehicle has stopped.

In embodiments, the program instructions cause the processor to detect a vehicle ahead potentially presenting an obstacle based on the sensor data, thereby providing obstacle detection data, and predict the upcoming deceleration event based on the obstacle detection data.

In embodiments, the program instructions cause the processor to detect a lane change and an obstruction during a lane change and predicts the upcoming deceleration event based on the obstruction.

In embodiments, the sensor data includes feedback from a turn signal detector. The deceleration prediction data describes whether the turn signal is for an upcoming right turn or an upcoming left turn and the default braking profile is adjusted differently for an upcoming left turn and an upcoming right turn.

In embodiments, the program instructions cause the processor to detect a stop event ahead based on the sensor data, thereby providing stop detection data, and predict the upcoming deceleration event based on the stop detection data.

In embodiments, the stop event is predicted based on sensor data from a map module, vehicle to vehicle sensor data, vehicle to infrastructure sensor data or based on sensor data from a vision system.

In embodiments, the program instructions cause the processor to detect a traffic light ahead based on the sensor data, thereby providing traffic light detection data, and predict the upcoming deceleration event based on the traffic light detection data. The state of the traffic light is detected and wherein the default braking profile is adjusted differently depending on whether the traffic light is green or red.

In another aspect, a vehicle providing one pedal driving (OPD) control capability, is provided. The vehicle includes a sensor operable to provide sensor data indicative of an upcoming deceleration event. A motor/generator is operable to generate traction torque and regenerative braking torque for the vehicle. The vehicle includes an accelerator pedal, and a processor in operable communication with the sensor, the accelerator pedal and the motor/generator. The processor is configured to execute program instructions. The program instructions cause the processor to receive accelerator pedal stroke data relating to the accelerator pedal, determine that regenerative braking is to be applied based on the accelerator pedal stroke data, predict an upcoming deceleration event based on the sensor data, thereby providing deceleration prediction data, adjust a default braking profile based on the deceleration prediction data, wherein the braking profile relates braking torque and at least pedal stroke position, generate a regenerative braking command based on the accelerator pedal stroke data and the adjusted braking profile, and output the regenerative braking command to the motor/generator.

In embodiments, the vehicle comprises a brake pedal. In embodiments, the vehicle includes friction brakes and the program instructions cause the processor to generate a friction braking command and the regenerative braking command.

In embodiments, the program instructions cause the processor to detect an obstacle ahead potentially presenting an obstacle based on the sensor data, thereby providing obstacle detection data, and predict the upcoming deceleration event based on the obstacle detection data. In embodiments, the obstacle is a vehicle.

In embodiments, the sensor data includes feedback from a turn signal detector.

In embodiments, the program instructions cause the processor to detect a stop event ahead based on the sensor data, thereby providing stop detection data, and predict the upcoming deceleration event based on the stop detection data.

In another aspect, a method for one-pedal driving (OPD) control for a vehicle is provided. The method includes receiving, via a processor, accelerator pedal stroke data relating to an accelerator pedal, determining, via the processor, that regenerative braking is to be applied based on the accelerator pedal stroke data, predicting, via the processor, an upcoming deceleration event based on sensor data from a sensor system of the vehicle, thereby providing deceleration prediction data, adjusting, via the processor, a default braking profile based on the deceleration prediction data, wherein the braking profile relates braking torque and at least pedal stroke position, generating, via the processor, a regenerative braking command based on the accelerator pedal stroke data and the adjusted braking profile, and outputting, via the processor, the regenerative braking command to a motor/generator of the vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes an OPD control system, in accordance with an exemplary embodiment;

FIG. 2 is a functional block diagram of the control system of the vehicle of FIG. 1, in accordance with an exemplary embodiment;

FIG. 3 is a functional block diagram of the OPD control system, in accordance with an exemplary embodiment;

FIG. 4 is a schematic depiction of an accelerator pedal used for OPD, in accordance with an exemplary embodiment;

FIG. 5 is a depiction of accelerator pedal position during OPD at different vehicle speeds, in accordance with an exemplary embodiment; and

FIG. 6 is a flowchart of a method for implementing OPD in a vehicle, which can be used in connection with the vehicle of FIG. 1, the control system of FIG. 2 and the OPD control system of FIG. 3, in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

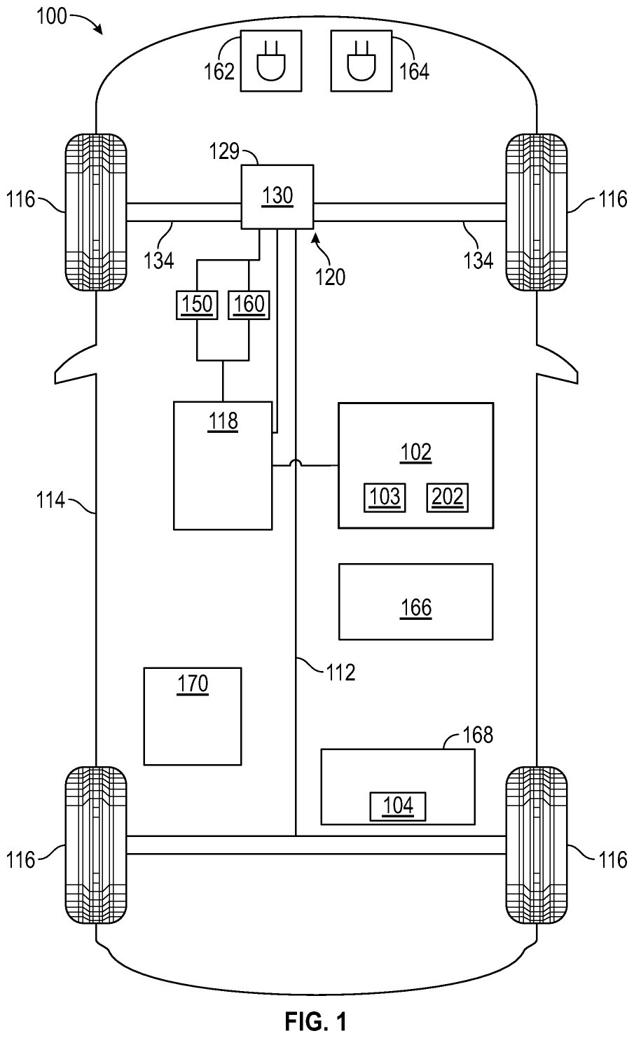

FIG. 1 illustrates a vehicle 100, or automobile, according to an exemplary embodiment. As described in greater detail further below, the vehicle 100 includes a control system 102 for implementation of one pedal driving (OPD) as described herein. OPD is an electric or hybrid vehicle feature that applies regenerative braking when coasting and will hold a vehicle stop without the brake pedal. OPD is enhanced with inputs from at least one of vehicle to vehicle/vehicle to infrastructure (V2X), an object detection system, a map module and other sensing systems. Regenerative braking of OPD is modified based on traffic light status, stop sign, lane change, intersection ahead, deceleration of the vehicle ahead, etc. OPD may be selected through a user interface menu in the vehicle with customizable deceleration level options including OPD off, low, medium, high and automatic. High applies the greatest amount of deceleration when lifting off the accelerator pedal. Automatic setting determines a braking profile adjustment based on predicted upcoming deceleration events. The vehicle may still include a paddle adjacent the steering wheel for selecting to apply regenerative braking at a higher braking force than lifting off the accelerator pedal. The OPD control system described herein may take inputs from at least one of a front long/short range radar, a V2X system, a front camera module (FCM), a map module, a turn signal sensor, a positioning system and a lidar system in order to predict an upcoming deceleration event and responsively to adjust a braking profile relating accelerator pedal position and braking force.

In one example, the OPD braking profile is adjusted (e.g. a different look up table is selected or the look up table is recalculated) based on when the vehicle is in a left/right turn lane and a distance to the turn is estimated. The system may determine whether a right or left turn is going to be taken based on at least one of a response from a turn indicator, based on input from a vision system, based on a navigation path from a map module, etc. The adjustment may differ depending on whether a right or a left turn is indicated. In another example, a stop sign ahead may be determined by the OPD control system. This determination may be made based on input from an FCM, a map module, etc. The OPD braking profile is adjusted when an upcoming stop sign is predicted. In a yet further example, the sensing system of the host vehicle detects that a vehicle ahead is decelerating. The look up table of the OPD braking profile is adjusted based on the detected deceleration of the vehicle ahead. In a further example, the FCM, the map module and/or V2X system indicates a traffic light ahead of the vehicle. The OPD braking profile is adjusted differently depending on whether the state of the traffic light is determined to be red and the time to green is known, the state of the traffic light is determined to be red and the time to green is unknown and the traffic light is green.

In another embodiment, after a certain amount of acceleration pedal liftoff has been detected (e.g. accelerator pedal liftoff is greater than a threshold), a deceleration profile (e.g. speed/braking force versus time) is adjusted to have the vehicle stop behind a target detected by a vision system of the vehicle. A sensing system detects a distance to the stop target and determines whether this is less than a nominal distance within which the vehicle would stop based on a default braking profile. An OPD deceleration trajectory is adjusted to stop behind the target. An amount of allowed adjustment could depend on pedal position to make the accelerator pedal feel more predictable for the driver. For example, more adjustment could be included the more the driver has lifted off the accelerator pedal or the adjustment could be provided only when the driver is fully off the accelerator pedal.

As depicted in FIG. 1, the vehicle 100 includes, in addition to the above-referenced control system 102, a chassis 112, a body 114, four wheels 116, an electronic control system 118, a steering system 150, and a braking system 160. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114. In various embodiments the vehicle 100 may differ from that depicted in FIG. 1. For example, in certain embodiments the number of wheels 116 may vary. By way of additional example, in various embodiments the vehicle 100 may not have a steering system, and for example may be steered by differential braking, among various other possible differences.

In the exemplary embodiment illustrated in FIG. 1, the vehicle 100 includes an actuator assembly 120. The actuator assembly 120 includes at least one propulsion system 129 mounted on the chassis 112 that drives the wheels 116. In the depicted embodiment, the actuator assembly 120 includes an electric motor/generator 130.

Still referring to FIG. 1, the motor/generator 130 is coupled to at least some of the wheels 116 through one or more drive shafts 134. In some embodiments, the motor/generator 130 is mechanically coupled to the transmission. In other embodiments, the motor/generator 130 may instead be coupled to a generator used to power an electric motor that is mechanically coupled to the transmission. In certain embodiments, a transmission may not be necessary.

The steering system 150 is mounted on the chassis 112, and controls steering of the wheels 116. The steering system 150 includes a steering wheel and a steering column (not depicted). The steering wheel receives inputs from a driver of the vehicle 100. The steering column results in desired steering angles for the wheels 116 via the drive shafts 134 based on the inputs from the driver. Similar to the discussion above regarding possible variations for the vehicle 100, in certain embodiments the vehicle 100 may not include a steering wheel and/or steering. In addition, in certain embodiments, an autonomous vehicle may utilize steering commands that are generated by a computer, with no involvement from the driver.

The braking system 160 is mounted on the chassis 112 and provides braking for the vehicle 100. The braking system 160 receives inputs from the driver via a brake pedal 162 and an accelerator pedal 164 and provides appropriate braking via friction brake units or via the regenerative braking via the electric motor/generator 130. Electricity generate during regenerative braking is used to charge the battery 166. The battery provides electricity to power the various components/systems of the vehicle 100 especially the control system 102 and the propulsion system 129. The driver also provides inputs via the accelerator pedal 164 as to a desired speed or acceleration of the vehicle, as well as various other inputs for various vehicle devices and/or systems, such as one or more vehicle radios, other entertainment systems, environmental control systems, lighting units, navigation systems, and the like (also not depicted). Friction braking and/or regenerative braking can be commanded based on a release position of the accelerator pedal 164 for OPD and/or based on an input from the brake pedal 162. The vehicle 100 may include a paddle associated with the steering wheel of the steering system 150 for commanding application of regenerative braking. Similar to the discussion above regarding possible variations for the vehicle 100, in certain embodiments steering, braking, and/or acceleration can be supplemented by a computer instead of by a driver (in one such embodiment, a computer of the vehicle may use input from the radar system to steer, brake, and/or accelerate the vehicle).

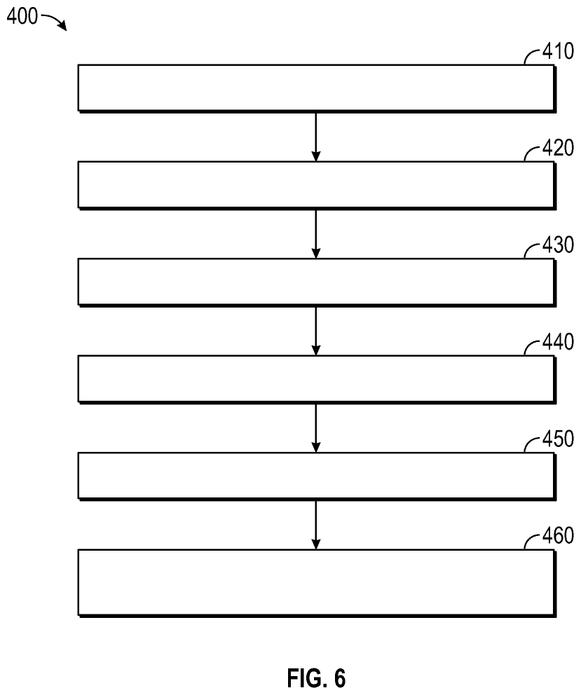

The control system 102 is mounted on the chassis 112. The control system 102 includes an OPD control system 202. The OPD control system 202 uses a sensor system 168 of the vehicle 100 (described further below) to predict an upcoming deceleration event and adjust a OPD braking profile based thereon. In one example, the amount of braking force by regenerative braking that is commanded is increased as compared to a default braking profile when an upcoming deceleration event within a certain distance of the vehicle 100 is predicted. The functions of the OPD control system 102 are further described in accordance with the method 400 of FIG. 6.

While the control system 102 and the OPD control system are depicted as being part of the same system, it will be appreciated that in certain embodiments these features may comprise two or more systems. In addition, in various embodiments the control system 102 may comprise all or part of, and/or may be coupled to, various other vehicle devices and systems, such as, among others, the actuator assembly 120, and/or the electronic control system 118.

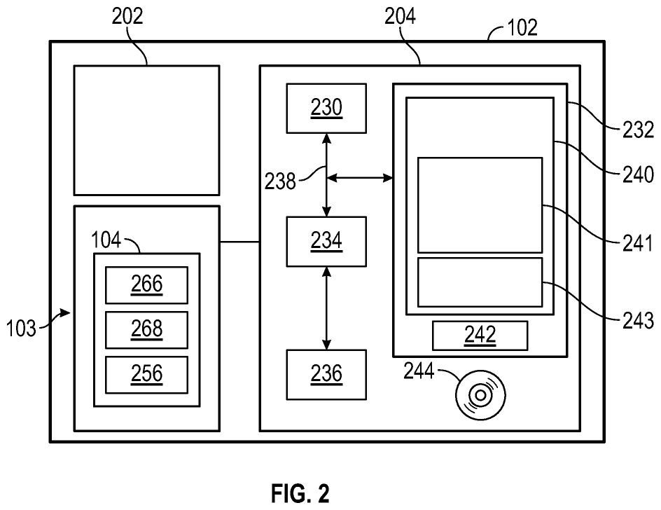

With reference to FIG. 2, a functional block diagram is provided for the control system 102 of FIG. 1, in accordance with an exemplary embodiment. As depicted in FIG. 2, the control system 102 includes an OPD control system 202 and a controller 204.

A vision system 103 includes one or more sensors 104. In the depicted embodiment, the sensors 104 include one or more cameras 266, range finding (radar) devices 256 and one or more light detection and ranging (LIDAR) systems 268. The camera(s) 266, LIDAR system(s) 268 and radars 256 obtain respective sensor information identifying objects on or near a road in which the vehicle 100 is travelling, such as moving or stationary vehicles on or alongside the road, pedestrians, bicyclists, animals, buildings, trees, guard rails, medians, and/or other objects on or alongside the road.

As depicted in FIG. 2, the controller 204 is coupled to the OPD control system 202 and the sensors 104. Similar to the discussion above, in certain embodiments the controller 204 may be disposed in whole or in part within or as part of the OPD control system 202. In addition, in certain embodiments, the controller 204 is also coupled to one or more other vehicle systems (such as the electronic control system 118 of FIG. 1).

As depicted in FIG. 2, the controller 204 comprises a computer system. In certain embodiments, the controller 204 may also include one or more of the OPD control system 202, sensor(s) 104, one or more other systems, and/or components thereof. In addition, it will be appreciated that the controller 204 may otherwise differ from the embodiment depicted in FIG. 2. For example, the controller 204 may be coupled to or may otherwise utilize one or more remote computer systems and/or other control systems, such as the electronic control system 118 of FIG. 1.

In the depicted embodiment, the computer system of the controller 204 includes a processor 230, a memory 232, an interface 234, a storage device 236, and a bus 238. The processor 230 performs the computation and control functions of the controller 204, and may comprise any type of processor or multiple processors, single integrated circuits such as a microprocessor, or any suitable number of integrated circuit devices and/or circuit boards working in cooperation to accomplish the functions of a processing unit. During operation, the processor 230 executes one or more programs 240 contained within the memory 232 and, as such, controls the general operation of the controller 204 and the computer system of the controller 204, generally in executing the processes described herein, such as the method 400 described further below in connection with FIG. 6. The one or more programs 240 include, inter alia, a regenerative braking control module 241 and an object detection module 243 for performing steps of method 400 described in detail below. Although regenerative braking control module 241 is shown included under computer programs in FIG. 2, it should be understood that the regenerative braking control module 241 could be stored as a computer program in memory of OPD control system 202 and executed by at least one processor of OPD control system 202.

The memory 232 can be any type of suitable memory. This would include the various types of dynamic random access memory (DRAM) such as SDRAM, the various types of static RAM (SRAM), and the various types of non-volatile memory (PROM, EPROM, and flash). In certain examples, the memory 232 is located on and/or co-located on the same computer chip as the processor 230. In the depicted embodiment, the memory 232 stores the above-referenced program 240 along with one or more stored values 242 for use in making the determinations.

The bus 238 serves to transmit programs, data, status and other information or signals between the various components of the computer system of the controller 204. The interface 234 allows communication to the computer system of the controller 204, for example from a system driver and/or another computer system and can be implemented using any suitable method and apparatus. The interface 234 can include one or more network interfaces to communicate with other systems or components. The interface 234 may also include one or more network interfaces to communicate with technicians, and/or one or more storage interfaces to connect to storage apparatuses, such as the storage device 236.

The storage device 236 can be any suitable type of storage apparatus, including direct access storage devices such as hard disk drives, flash systems, floppy disk drives and optical disk drives. In one exemplary embodiment, the storage device 236 comprises a program product from which memory 232 can receive a program 240 (including control modules 241 and 243) that executes one or more embodiments of one or more processes of the present disclosure, such as the steps of the method 400 (and any sub-processes thereof) described further below. In another exemplary embodiment, the program product may be directly stored in and/or otherwise accessed by the memory 232 and/or a disk (e.g., disk 244), such as that referenced below.

The bus 238 can be any suitable physical or logical means of connecting computer systems and components. This includes, but is not limited to, direct hard-wired connections, fiber optics, infrared and wireless bus technologies. During operation, the program 240 is stored in the memory 232 and executed by the processor 230.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 230) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system of the controller 204 may also otherwise differ from the embodiment depicted in FIG. 2, for example in that the computer system of the controller 204 may be coupled to or may otherwise utilize one or more remote computer systems and/or other control systems.

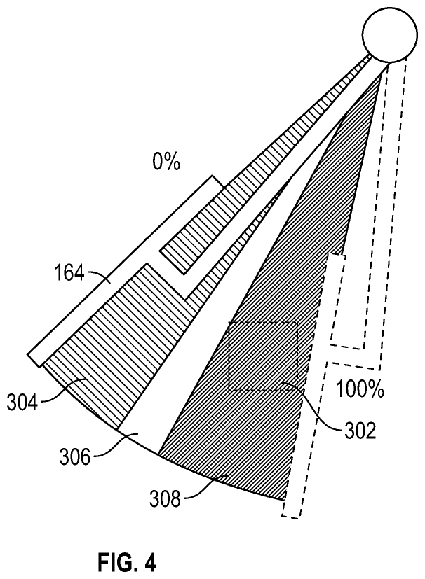

FIG. 4 provides a schematic depiction of an accelerator pedal 164 that can be progressively depressed from a 0% pedal depression position and a 100% pedal depression position and back again. The accelerator pedal 164 is associated with an accelerator pedal sensor 302 that provides pedal stroke data including pedal position. In some embodiments, the pedal sensor provides further pedal stroke data such as rate of change of pedal position. For any given vehicle moving speed, the accelerator pedal 164 will have an acceleration region 308, a regeneration region 304 and a cruising region 306 in between. In the acceleration region, is operating as a motor and traction force is applied to the vehicle 100 via the propulsion system 129 so that the vehicle 100 accelerates. In the regeneration region 304, the motor/generator 130 is operating as a generator and regenerative braking is being applied to decelerate the vehicle 100. In the limited size cruising region 306, a balance point is reached in which the vehicle 100 is neither accelerating nor decelerating. The cruising region 306 pedal position changes dynamically depending on the speed of the vehicle 100. The faster the vehicle 100, the smaller the acceleration region 308 and the larger the regeneration region 34.

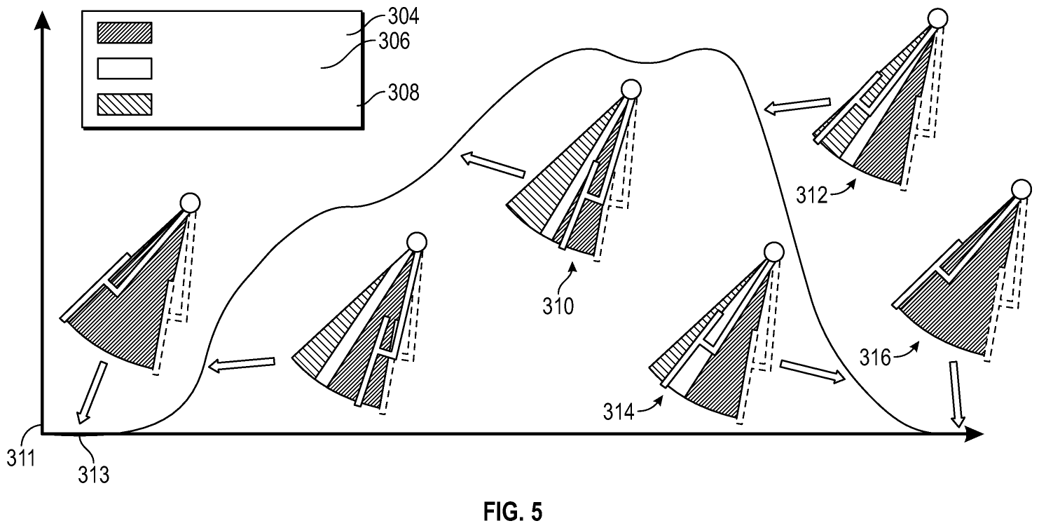

FIG. 5 depicts an exemplary graph of vehicle speed on axis 311 with respect to time on axis 313. As can be seen, the cruising region 306 dynamically adapts with vehicle speed so as to be positioned closer to the zero percent pedal position at low vehicle speed and closer to the 100% pedal depression position at higher vehicle speeds. Referring to the accelerator pedals 310, 312, 314, 316 of FIG. 5, these show the accelerator pedal stroke transitioning from an acceleration region 308 for pedal 310 to a regeneration region 304 for pedals 312, 314, 316. Accelerator pedal liftoff is gradually increased from pedal 312 to pedal 316 to bring the vehicle to a complete stop when the accelerator pedal 316 has been completely released. As illustrated, the vehicle acceleration, declaration and stop events for the drive illustrated in FIG. 5 is handled entirely through the accelerator pedal 164, thereby providing for OPD. At the system level, the accelerator pedal sensor 302 provides sensor data and a vehicle speed sensor (not shown) provides vehicle speed data. The OPD control system 202 receives this data and accesses a braking profile, which can be a multi-dimensional look up table in some embodiments. Based on at least vehicle speed and pedal stroke data as inputs, the OPD control system 202 obtains a braking torque from the braking profile and generates regenerative braking commands that are implemented by the electric motor/generator 130 operating as a generator to recharge the battery 166. In some situations (e.g. battery charge full state) the braking commands may be sent to friction brakes or a combination of regenerative and friction braking. However, the majority of braking actions during OPD will be executed through the generator function of the electric motor/generator 130.

The following Table 1 provides an example of a braking/propulsion profile in the form of a look-up table that relates accelerator pedal position, vehicle speed and nominal braking or traction force (at the axle) applied by the electric motor/generator 130:

TABLE 1

| Accel Pedal | | | | | | |
|---|---|---|---|---|---|---|
| Position (%) | Nominal Force (Nm at axle) | | | | | |
| 100% | 2000 | 2000 | 2000 | 2000 | 1500 | 1200 |
| | 1800 | 1800 | 1800 | 1800 | 1200 | 900 |
| | 1600 | 1200 | 1200 | 1200 | 900 | 700 |
| | 1200 | 800 | 700 | 700 | 500 | 500 |
| | 800 | −100 | −200 | −200 | −100 | −50 |
| 0% | 0 | −500 | −1000 | −1000 | −800 | −500 |

| | | |
|---|---|---|
| 0 kph | Vehicle Speed | 160 kph |

Negative force numbers in Table 1 correspond to regenerative braking being applied. In some embodiments, a rate limiting function is applied to cap a maximum rate of change of braking force applied. In some existing vehicles, there may be more than one such braking profile and an OPD control system will use one of the braking profiles depending on a user setting input. Thus, a user may choose between a high braking force and a low braking force setting and a high braking/propulsion profile will reflect a higher braking torque being applied for the same pedal position and vehicle speed than the low braking/propulsion profile. The OPD control systems and methods of the present disclosure provide a smarter and automated change or adjustment of braking profiles that are responsive to detected upcoming deceleration events. That is, an upcoming deceleration event is predicted, and the braking profile is adjusted to generally increase the braking force applied when a sensor system provides data indicating that a stop or other deceleration event is coming. In this way, regenerative braking is applied at an appropriate force that can maximize regeneration of the battery 166 without unacceptably adversely affecting drive feel. Furthermore, the change in OPD braking is carried out without relying on a driver identifying upcoming regeneration opportunities, which frees the driver's cognitive capabilities for concentrating on other driving functions.

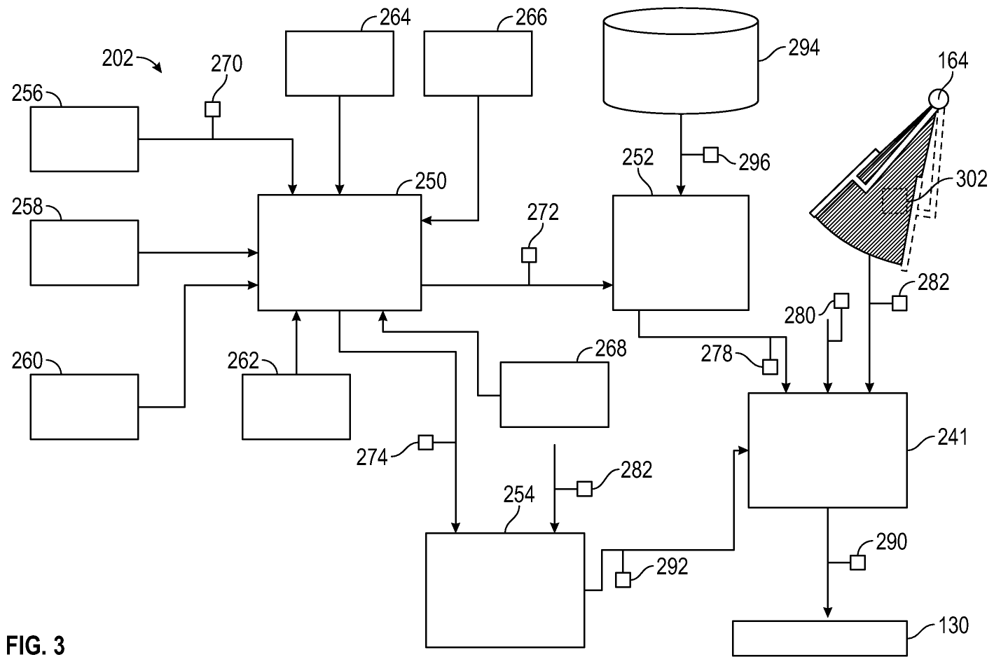

Turning to FIG. 3, the exemplary OPD control system 202 of FIG. 3 includes a deceleration prediction module 250, a regenerative braking adjustment module 252, a deceleration profile adjustment module 254, a regenerative braking control module 241, the accelerator pedal 164, the accelerator pedal sensor 302 and the electric motor/generator 130, which will be described in further detail in the following.

The deceleration prediction module 250 receives inputs from at least one of the following sensing systems: a radar system 256 (including a front long/short range radar), a map module 258, a turn signal detector 260, a positioning system 151, a lidar system 268, a camera system 266 (includinlg a front camera module) and a V2X system 264. The inputs from different sensing systems provide the deceleration prediction module 250 with data 270 indicative of an upcoming deceleration event. In one example, a stop sign, traffic light or other road sign or other road infrastructure (such as an intersection) may indicate an upcoming requirement to decelerate the vehicle to a stop and this can be detected by the camera system 266, the map module 258 (which tracks the route of the vehicle 100 on a map using, for example, a GPS sense of current position coming from the positioning system 262), the lidar system 268 or the V2X system 264, or a combination thereof. In another example, an object (such as a vehicle) presenting an upcoming obstacle that will require deceleration can be detected by the V2X system 264, the camera system 266 or the radar system 256, or a combination thereof. The deceleration prediction module 250 processes the data 270 provided by such sensing systems to predict when there is an upcoming deceleration event. The deceleration prediction module 250 may output deceleration prediction data 272 embodying a prediction of an upcoming deceleration event. The deceleration prediction data 272 may also describe (in distance or time units) an immediacy of a required braking action. In the latter case, the deceleration prediction module 250 determines or estimates a change in speed required and a distance over which that change in speed will be required based on the context of the obstacle position and deceleration rate (if a moving vehicle), based on whether the vehicle 100 will come to a complete stop or merely slow as it approaches a junction, based on amount and behavior of surrounding traffic and other road context information. When the vehicle 100 is predicted to need to stop (e.g. because of a stop sign or red traffic light), the deceleration prediction module 250 may output target stop location data 274 providing an indication of where the target stop location will be. This can be determined based on where the location of the stop sign or traffic light is and the amount of intervening traffic or where and how fast a vehicle ahead is decelerating or the location of an unexpected obstacle in the road, etc.

The regenerative braking adjustment module 252 receives the deceleration prediction data 272 and determines whether a regenerative braking portion of a default traction/braking profile (see Table 1 above for an example) should be adjust based thereon and what adjustment should be made. In a simple form, the adjustment may be to switch from a relatively low braking force profile to a relatively high braking force profile when the deceleration prediction data 272 indicated an upcoming deceleration event. In this way, the amount of braking force applied per unit movement of pedal position is increased when a deceleration event is predicted. The adjustment between relatively low and high braking force profiles could be implemented by loading respective regenerative braking profile data 296 from a regenerative braking profiles database 294. The adjustment includes an increase in maximum braking force at a fully released pedal position and a blended change from the fully released pedal position to the cruising region 306. That is, the braking force for the whole braking profile is changed from the cruising region throughout the regeneration region 304. Whilst the profile change may be executed by switching between a plurality of pre-stored braking profiles in the regenerative braking profiles database 294 in one embodiment, a real-time recalculation of the braking force could be applied to a default braking profile using a variable gain factor in another embodiment. A plurality of different levels of braking profile could be utilizes including low and high in one embodiment, low, medium and high in another embodiment or including further or continuous levels in yet further embodiments. In some embodiments, the deceleration prediction data 272 indicates a type of deceleration event (e.g. an unexpected obstacle versus a stop sign) or indicates an immediacy of the deceleration event as descried above. Different types or immediacy of deceleration events can be transformed into more aggressive regenerative braking profiles (e.g. a greater increase in regenerative braking force per unit liftoff of the accelerator pedal 164) by the regenerative braking adjustment module 252. The regenerative braking adjustment module 252 adjusts a current or default regenerative braking profile based on the deceleration prediction data 272 and outputs adjusted regenerative profile data 278 describing the adjusted braking profile.

The regenerative braking control module 241 receives vehicle speed data 280 and pedal stroke data 282 as inputs to determining a braking torque from the braking profile defined by the adjusted regenerative profile data 278. Vehicle speed data 280 can be obtained from one or more wheel sensors, from the positioning system 262 or from any other sensing system capable of accurately providing the speed of the vehicle 100. The pedal stroke data 282 includes pedal position from the accelerator pedal sensor 302 and may be provided as a percentage of total depression from 0% to 100%. Based on the obtained braking force, a regenerative braking command 290 is output to the electric motor/generator 130 to implement the braking force through, usually, regenerative braking. However, in some instances, friction braking may be commanded in addition to, or in place of, the regenerative braking command 290 such as when the battery 166 is already fully charged. A rate limiting function may be included in the regenerative braking control module 241 to ensure that a rate of change of braking force does not exceed a defined limit.

In addition to the adjusting a regenerative braking profile based on predicted upcoming deceleration events, a deceleration profile determination module 254 may be provided that calculates a deceleration trajectory in certain situations. In particular, when the pedal has been released beyond a certain threshold, a relatively high braking force will be commanded by the OPD control system 202. The deceleration profile determination module 254 may override the deceleration profile that would be implemented by the default or adjusted braking profiles by increasing or decreasing a braking force applied so as to stop at a target position, e.g. a set distance behind a detected vehicle ahead or at a stop sign or at a traffic light. Thus, the deceleration rate that is applied through regenerative braking by the OPD control system 202 is set so as to be as gradual as possible whilst still stopping at the target without using the brake pedal 162. This can enhance a smooth feel of the OPD driving experience. He deceleration profile determination module 254 receives accelerator pedal stroke data 282 and target stop location data 274 defining a target stop location. The deceleration profile determination module 254 determines that the driver has lifted off the accelerator pedal 164 by an amount greater than a threshold, e.g. there is 10% or less movement range left in the upward pedal stroke. The deceleration profile determination module 254 further determines how much braking force will be required to stop at the target stop position defined in the target stop location data. When the braking force is greater than that defined by the regenerative braking profile 252 generated by the regenerative braking adjustment module, the braking force is increased and when the braking force is less than that defined by the regenerative braking profile generated by the regenerative braking adjustment module 252, the braking force may be decreased. In one example, the adjustment might be only provided when the driver has fully released the accelerator pedal 164 or the adjustment might be to progressively increase the braking force adjustment as pedal liftoff is increased. The adjustment of the braking force might be up to a certain maximum. The deceleration profile determination module 254 thus outputs deceleration trajectory data 292 including a braking force profile, which may be in the form of braking force over time or distance when a stop target is determined and when a certain threshold pedal liftoff has been detected. The regenerative braking control module 241 determines the regenerative braking command based additionally on the deceleration trajectory data 292 in order to bring the vehicle 100 to a stop at the target stop position. It should be appreciated that the deceleration profile determination module 254 and the regenerative braking adjustment module 252 may be provided together or they may be included in a vehicle independently of one another.

In the exemplary embodiment of FIG. 1, the vehicle 100 includes a user interface 170 allowing a user to activate or deactivate the context adaptive OPD control system 202 described herein. That is, the user interface 170 can allow a user to turn off OPD driving, activate OPD with fixed regenerative braking profiles such as low or high or low medium or high or to activate an automatic setting. Under the automatic setting, the sensing system adaptive braking profiles are produced through the deceleration prediction module 250, the deceleration profile determination module 254 and the regenerative braking adjustment module 252 as described with respect to FIG. 3. The user interface 170 can include a graphical display device or an instrument panel showing the current settings and the options of at least low, high and automatic. The user interface 170 can include a knob, a button, a lever, a touchscreen or any other user input device for selecting which of the OPD control system options should be enabled and disabled.

Examples of operation of the OPD control system 202 will be described in the following. In an example without OPD activated, the driver is cruising with a foot on the accelerator pedal 164. The driver then lifts off the accelerator pedal 164 to coast as the stop sign approaches. In this instance, since OPD regenerative braking is not being applied, the driver starts to press the brake pedal to decelerate and stop as the stop sign nears.

In a first example of automatic OPD being activated, the driver is cruising with a foot on the accelerator pedal 164. The OPD control system 202 detects a stop sign (or other deceleration event) through a sensing system. The OPD vehicle control system 202 adjusts a maximum braking level as part of the adjusted regenerative profile data 278. The driver subsequently lifts off the accelerator pedal 164 and the system applies braking at a faster rate (per unit pedal travel) than the default regenerative braking profile data 296. The driver may completely lift off the accelerator pedal 164 when ready to come to a stop. In this case, the OPD control system 202 provides a higher level of maximum braking than what is needed to stop behind the sign. The OPD control system 202 only increases the regenerative braking level, not decreasing it, and would reset to default braking at a stop, or when the accelerator pedal 164 is actuated beyond the regeneration region 304.

In a second example of automatic OPD being activated, the driver is cruising with a foot on accelerator pedal 164. The driver lifts off the accelerator pedal 164 to coast as a stop sign approaches before the sensor system detects the stop sign (for example). The OPD control system 202 detects the stop sign and adjusts the maximum braking level through the regenerative braking adjustment module 252. The OPD control system 202 transitions from the lower default braking profile to the higher adjusted braking profile such that the vehicle 100 decelerates faster and comes to a stop at the stop sign. In this case, the driver lifted off the accelerator pedal 164 before the OPD driving control system 202 had adjusted the braking level. The braking force should be adjusted to bring the vehicle to a complete stop at the identified object, optionally by way of the deceleration profile determination module 254.

In a third example, automatic OPD is not activated in that the regenerative braking adjustment module 252 is disabled. However, the driver has already set the braking profile to high through the user interface 170 and the OPD control system 202 is set such that the deceleration profile determination module 254 is enabled. In the present example, the driver is cruising with a foot on the accelerator pedal 164. The driver partially lifts off the accelerator pedal to decelerate as the stop sign approaches. Next, the OPD control system 202, specifically the deceleration prediction module 250 in conjunction with the various sensing system components 256 to 268, detects a stop sign (or other stop causing detection), and adjusts the maximum braking level to achieve a target stop position through use of the deceleration profile determination module 254. The driver completely lifts off the accelerator pedal. The vehicle decelerates faster that that suggested by the high braking profile from the regenerative braking profiles database 294. The vehicle 100 comes to a stop at the target stop sign. In this case, the maximum level is adjusted (within limits) to a point that stops the vehicle 100 at the identified object, which is a stop in this example.

In a fourth example of automatic OPD, the deceleration prediction module 250 detects a turn signal activated by the driver based on an input from the turn signal detector 260. The deceleration prediction module 250 further uses other sensors of the sensing system such as the map module 258 and the V2X system 264 to determine a likelihood of a lane change. Further, using sensors (such as radar system 256, lidar system 268, camera system 266, V2V system), the deceleration prediction module 250 identifies a vehicle obstructing the intended lane. The combination of a lateral obstruction and a lane change in that direction allows the deceleration prediction module 250 to predict a deceleration event. The regenerative braking adjustment module 252 is responsive thereto by increasing maximum regenerative braking (as part of the braking profile adjustment) to help facilitate speed adjustment for a lane change.

In some embodiments, road grade is detectable by vehicle sensors such as the map module 258 and inertial sensors of the vehicle 100. The regenerative braking adjustment module 252 may take into account road grade in determining the amount of regenerative braking profile adjustment, e.g. uphill grade requires a lower braking profile adjustment than flat and downhill grades.

FIG. 6 is a flowchart of a method 400 for implementing an OPD control system 202 of a vehicle 100, in accordance with an exemplary embodiment. The method 400 can be implemented in connection with the vehicle 100 of FIG. 1, the control system 102 of FIGS. 1 and 2, the OPD control system 202 and controller 204 of FIG. 2, and the OPD control system 202 of FIGS. 1-3, in accordance with an exemplary embodiment. The method may be performed when an automatic OPD control system setting has been enabled by a user through a user interface 170. The deceleration profile setting part of the method described with respect to step 440 may be active even when the automatic OPD control system 202 setting is disabled.

In step 410, an upcoming deceleration event is predicted in the OPD control system 202. Under step 410, deceleration prediction module 250 receives data 270 indicative of an upcoming deceleration event such as data from the radar system 256, the map module 258, the turn signal detector 260, the positioning system 262, the lidar system 268, the camera system 266 and the V2X system 264. The deceleration events that are detectable can be junctions, path turns, bends, stop signs, traffic lights, unexpected obstacles (e.g. roadways or a pedestrian in the road, stop signs, etc.

In step 420 a default braking profile obtained from the database 294 is adjusted in response to the deceleration event. The adjustment is, generally, to increase a regenerative braking force for a given vehicle speed and pedal position as a result of the detected deceleration event.

In step 430, the driver lifts off from an accelerator pedal 164 to enter a regeneration region 304. A braking force is determined by the regenerative braking control module 241 based on the adjusted regenerative profile from step 420 and based on a pedal position received from the accelerator pedal sensor 302. A corresponding regenerative braking command 290 may be determined and output in step 450. The electric motor/generator 130 may apply the braking command to achieve the target braking force, thereby performing step 460. In other embodiments, the deceleration event that is predicted in step 410 is a stop event. Optional step 440 may be included by which a deceleration trajectory is calculated so as to achieve a target stopping position. The deceleration trajectory may be calculated when the pedal liftoff is greater than a set minimum (e.g. full release of the accelerator pedal 164) and when the default or adjusted regenerative braking profile is not able to stop the vehicle 100 at the target location. The regenerative braking command is generated in step 450 based on the adjusted regenerative profile data 278 of step 420 when the accelerator pedal 164 is released to a position below the threshold and based on the deceleration trajectory of step 440 when the accelerator pedal 164 is moved beyond the threshold. Steps 430 and 450 may not necessarily be applied in combination. The present disclosure envisages embodiments where the deceleration profile determination module 254 is provided separately from the regenerative braking adjustment module 252. The present disclosure further envisions embodiments, where the OPD braking is applied friction brakes, at least in part.

In one example of method 400, the vision system 103 of the vehicle 100 detects that a vehicle ahead is decelerating and/or this is detected by the V2X system 264 in step 410. In addition to checking for deceleration of the vehicle ahead, the vision system 103 and the OPD control system 202 may also check that the vehicle is in the same lane and thus truly an obstacle. The OPD braking profile is adjusted by the regeneration braking adjustment module 252 in step 420. The braking commands are generated based on the adjusted profile and implemented by the electric motor/generator 130 in steps 450 and 460.

In another example of method 400, the deceleration prediction module 250 receives detection of a turn signal being on from the turn signal detector 260 or from another indication of an upcoming turn like from a navigation path defined by the map module 258 in step 410. Different levels of braking profile adjustment may be determined in step 420 based on whether the turn is a right turn (assuming a right hand drive country) or a left turn. A left turn is more likely to require a complete stop whereas a right turn is more likely to require slowing but no stopping. Thus, for left turns a less aggressive braking profile adjustment may be selected than for right turns, although both braking profiles would have a higher braking force for a given speed and pedal position than the default braking profile.

In a yet further example of method 400, the camera system 266 or the map module 258 may indicate an upcoming stop sign ahead of the vehicle 100 in step 410. The braking profile is adjusted in step 420 to increase the braking force across different speed and braking force combinations by application of a gain multiplier or by retrieval of a different braking profile from the database 294. When the driver releases the accelerator pedal 164 from the cruising region 306 o the regeneration region 304, the adjusted profile is used to determine and implement the braking commands in steps 450 and 460.

In another example of method 400, the camera system 266 or the map module 258 or the V2X system 264 provides an indication of a traffic light ahead of the vehicle 100, which leads to a prediction of an upcoming deceleration event in step 410. The deceleration prediction module 250 may further report in the deceleration prediction data 272 whether the traffic light status is green or red and, if red, the time to green (if known). This results in multiple different possible adjustments to the regenerative braking profile in step 420 when the accelerator pedal 164 is at least partly released. Specifically, a relatively low, medium and high braking profile can be calculated or selected depending on whether the traffic light is green, red (optionally also yellow is factored in) with a long wait time or red with a short wait time.

In an additional example of method 400, step 440 is invoked when the driver lift off the accelerator pedal 164 is greater than a threshold and the deceleration prediction module 250 determines, in step 440, that a target stop distance is less than would be achieved with a current or default braking profile. In this instance, the regenerative braking command 450 is determined so as to achieve a deceleration trajectory that is calculated by the deceleration profile determination module 254 to stop at the target stop position. The regenerative braking commands are generated and implemented in steps 450 and 460.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A one-pedal driving (OPD) control system for a vehicle, comprising:
at least one sensor operable to provide sensor data indicative of an upcoming deceleration event;
a motor/generator operable to generate traction torque and regenerative braking torque for the vehicle;
at least one processor in operable communication with the at least one sensor and the motor/generator, the at least one processor configured to execute program instructions, wherein the program instructions are configured to cause the at least one processor to:
receive accelerator pedal stroke data relating to an accelerator pedal;
determine that regenerative braking is to be applied based on the accelerator pedal stroke data;
predict an upcoming deceleration event based on the sensor data, thereby providing deceleration prediction data;
adjust a default braking profile based on the deceleration prediction data, wherein the braking profile relates braking torque and at least pedal stroke position;
generate a regenerative braking command based on the accelerator pedal stroke data and the adjusted braking profile; and
output the regenerative braking command to the motor/generator.

2. The OPD control system of claim 1, wherein the default braking profile relates at least accelerator pedal stroke position, vehicle speed and braking torque.

3. The OPD control system of claim 1, wherein the program instructions are configured to cause the at least one processor to:
determine whether an amount of liftoff of the accelerator pedal has reached a predetermined level based on the pedal stroke data; and when the predetermined level has been reached,
determine a target stop position based on the sensor data;
set a deceleration trajectory to stop at the target position; and
generate the regenerative braking command based additionally on the deceleration trajectory.

4. The OPD control system of claim 1, wherein the program instructions are configured to cause the at least one processor to:
generate the regenerative braking command based on the accelerator pedal stroke data and the default braking profile when no upcoming deceleration is predicted; and
generate the regenerative braking command based on the accelerator pedal stroke data and the adjusted braking profile when upcoming deceleration is predicted;
wherein the adjusted braking profile has a greater rate of change of braking torque per unit of accelerator pedal movement than the default braking profile.

5. The OPD control system of claim 1, wherein the program instructions are configured to cause the at least one processor to:
reset to generating the regenerative braking command based on the accelerator pedal stroke data and the default braking profile after the accelerator pedal stroke data indicates that the accelerator pedal has returned to a cruise or acceleration region or after the vehicle has stopped.

6. The OPD control system of claim 1, wherein the program instructions are configured to cause the at least one processor to:
detect a vehicle ahead potentially presenting an obstacle based on the sensor data, thereby providing obstacle detection data; and
predict the upcoming deceleration event based on the obstacle detection data.

7. The OPD control system of claim 1, wherein the sensor data includes feedback from a turn signal detector.

8. The OPD control system of claim 7, wherein the deceleration prediction data describes whether the turn signal is for an upcoming right turn or an upcoming left turn and the default braking profile is adjusted differently for an upcoming left turn and an upcoming right turn.

9. The OPD control system of claim 1, wherein the program instructions are configured to cause the at least one processor to:
detect a stop event ahead based on the sensor data, thereby providing stop detection data; and
predict the upcoming deceleration event based on the stop detection data.

10. The OPD control system of claim 9, wherein the stop event is predicted based on sensor data from a map module, vehicle to vehicle sensor data, vehicle to infrastructure sensor data or based on sensor data from a vision system.

11. The OPD control system of claim 1, wherein the program instructions are configured to cause the at least one processor to:
detect a traffic light ahead based on the sensor data, thereby providing traffic light detection data; and
predict the upcoming deceleration event based on the traffic light detection data.

12. The OPD control system of claim 11, wherein the state of the traffic light is detected and wherein the default braking profile is adjusted differently depending on whether the traffic light is green or red.

13. A vehicle providing one pedal driving (OPD) control capability, comprising:
at least one sensor operable to provide sensor data indicative of an upcoming deceleration event;
a motor/generator operable to generate traction torque and regenerative braking torque for the vehicle;
an accelerator pedal;
at least one processor in operable communication with the at least one sensor, and the motor/generator, the at least one processor configured to execute program instructions, wherein the program instructions are configured to cause the at least one processor to:
receive accelerator pedal stroke data relating to the accelerator pedal;
determine that regenerative braking is to be applied based on the accelerator pedal stroke data;
predict an upcoming deceleration event based on the sensor data, thereby providing deceleration prediction data;
adjust a default braking profile based on the deceleration prediction data, wherein the braking profile relates braking torque and at least pedal stroke position;
generate a regenerative braking command based on the accelerator pedal stroke data and the adjusted braking profile; and
output the regenerative braking command to the motor/generator.

14. The vehicle of claim 13, wherein the vehicle comprises a brake pedal.

15. The vehicle of claim 13, wherein the vehicle includes friction brakes and wherein the program instructions are configured to cause the at least one processor to:
generate a friction braking command and the regenerative braking command.

16. The vehicle of claim 13, wherein the program instructions are configured to cause the at least one processor to:
detect an obstacle ahead potentially presenting an obstacle based on the sensor data, thereby providing obstacle detection data; and
predict the upcoming deceleration event based on the obstacle detection data.

17. The vehicle of claim 16, wherein the obstacle is a vehicle.

18. The vehicle of claim 13, wherein the sensor data includes feedback from a turn signal detector.

19. The OPD control system of claim 1, wherein the program instructions are configured to cause the at least one processor to:
detect a stop event ahead based on the sensor data, thereby providing stop detection data; and
predict the upcoming deceleration event based on the stop detection data.

20. A method for one-pedal driving (OPD) control for a vehicle, comprising:
receiving, via at least one processor, accelerator pedal stroke data relating to an accelerator pedal;
determining, via the at least one processor, that regenerative braking is to be applied based on the accelerator pedal stroke data;
predicting, via the at least one processor, an upcoming deceleration event based on sensor data from a sensor system of the vehicle, thereby providing deceleration prediction data;
adjusting, via the at least one processor, a default braking profile based on the deceleration prediction data, wherein the braking profile relates braking torque and at least pedal stroke position;
generating, via the at least one processor, a regenerative braking command based on the accelerator pedal stroke data and the adjusted braking profile; and
outputting, via the at least one processor, the regenerative braking command to a motor/generator of the vehicle.
